(19) United States
(12) Patent Application Publication
(10) Pub. No.: US 2016/0019135 A1
(43) Pub. Date: Jan. 21, 2016

(54) OPTIMAL TEST SUITE REDUCTION AS A NETWORK MAXIMUM FLOW

(71) Applicant: Simula Innovation AS, Fornebu (NO)

(72) Inventors: Arnaud GOTLIEB, Oslo (NO); Dusica MARIJAN, Fornebu (NO)

(21) Appl. No.: 14/801,101

(22) Filed: Jul. 16, 2015

Related U.S. Application Data
(60) Provisional application No. 62/026,923, filed on Jul. 21, 2014.

(51) Int. Cl. G06F 11/36; G06N 5/00

(52) U.S. Cl. CPC G06F 11/3688; G06N 5/003

(57) ABSTRACT

A novel approach to test-suite reduction based on network maximum flows. Given a test suite T and a set of test requirements R, the method identifies a minimal set of test cases which maintains the coverage of test requirements. The approach encodes the problem with a bipartite directed graph and computes a minimum cardinality subset of T that covers R as a search among maximum flows, using the classical Ford-Fulkerson algorithm in combination with efficient constraint programming techniques. Test results have shown that the method outperforms the Integer Linear Programming (ILP) approach by 15-3000 times, in terms of the time needed to find the solution. At the same time, the method obtains the same reduction rate as ILP, because both approaches compute optimal solutions. When compared to the simple greedy approach, the method takes on average 30% more time and produces from 5% to 15% smaller test suites.

### CROSS-REFERENCE TO RELATED APPLICATION

This application is related to and claims priority to U.S. Provisional Patent Application Ser. No. 62/026,923, filed Jul. 21, 2014, entitled “OPTIMAL TEST SUITE REDUCTION AS A NETWORK MAXIMUM FLOW”, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for reducing the size of a test suite while preserving its overall quality.

### BACKGROUND OF THE INVENTION

As software evolves over time, test suites or test configurations used to validate the software grow. On the other hand, according to several studies, test suite size has a large impact on the overall test cost in the software development lifecycle. Therefore, a trend in software testing is to keep the test suite size as small as possible, while preserving the “quality” of the test suite (e.g., its requirements coverage rate, its overall running time, its expected fault-detection rate or a combination of those). For software testing contexts where executing a single test case requires much manual effort and preparation, finding the smallest set of test cases is essential to keep the test cost as low as possible.

Test suite reduction, also called a test suite minimization, is a general problem cross-cutting several related research areas. In code-based testing where test requirements correspond to code coverage objectives, the goal is to minimize a test suite while preserving code coverage. In functional testing with combinatorial interaction testing, test suite reduction aims at selecting the smallest test suite covering all N-tuples of input parameters. In software product line testing, a challenge is to find the minimal number of test configurations so that all product line features are covered at least once. In regression testing, test suite reduction aims at finding the smallest subset of test cases preserving the error-detection ability of the original test suite. These examples reveal that the main problem, i.e. test suite reduction, is of a fundamental nature and deserves to be explored in all possible dimensions. Optimal test suite reduction is obtained when the subset is of minimum cardinality. However, the problem of finding a minimum-cardinality subset (not necessarily unique!), known as a Minimum Set Cover, is NP-complete. In the worst case, the time required to compute a minimum-cardinality subset grows exponentially with the size of the problem.

Substantial research work has addressed different variations of this problem. In addition to this problem, authors have also considered test suite prioritization techniques in regression testing and experimental studies. However, most common approaches proposed in the literature exhibit some of the following three drawbacks:

Minimum-cardinality test suite is not guaranteed. Commonly used approaches to compute the minimum cardinality subsets exploit greedy algorithms to find the test cases covering the set of test requirements. For example, they select first the test case that covers the most test requirements, then remove all requirements covered by the selected test case and repeat the process until all requirements are covered. While generally quick, greedy algorithms can only approximate the global-optimum solutions. Once a test case is selected, the choice is usually not reconsidered to find another test case covering less, but different requirements. An exact method, on the contrary, is a method able to compute a minimum-cardinality subset.

Tradeoff between test-reduction time and number of test cases. Exact approaches based on Integer Linear Programming (ILP), are able to find a (non-approximated) optimal solution, but at the cost of long run time. On the other hand, greedy heuristics exhibit better runtime, but usually at the cost of larger test suites. Both minimum-cardinality test suite and low runtime are important aspects of test suite reduction in practice and therefore, there is usually a need for a tradeoff.

Fault-detection capability or code coverage is not preserved. When looking only at the size of test suites, while preserving requirements coverage, test suite reduction can compromise other essential characteristics, such as fault revealing capability or code coverage. Some of the recent approaches to test suite reduction have addressed this problem by combining multi-objective optimization methods and search-based test data generation or Integer Linear Programming. However, there is still a challenge to understand how to balance between these criteria and how to select optima in a multi-objective optimization problem.

Generally speaking, test-suite reduction techniques can be classified in two groups: greedy approaches and exact methods.

Greedy approaches. Early work on selecting test cases to cover test requirements has been previously reported. It is a classical approximation approach for the minimum set-cover problem based on a greedy heuristic. The heuristic suggests selecting first the test case that covers the most of uncovered requirements and repeats the process until all requirements are covered at least once. Prior art references analyzed and reported the upper bound on the distance to the true minimum given by this heuristic in the worst case. The limitation of greedy approaches is that the reduced test suite may contain redundant test cases. Some have proposed a technique that outperforms in terms of solution size, by approximating the computation of minimum cardinality hitting sets. However, the experimental evaluation confined to less than a few tens of test cases and requirements. A variation of the greedy approach to test suite reduction is has been presented where, instead of using a fixed test case ordering, the authors proposed different orderings. The technique has been specialized to handle the coverage of statements and branches in the test suite. Similarly, formulating test suite minimization as a problem of finding a spanning set over a graph has been proposed. In that approach, the SUT structure is represented by a decision-to-decision graph (ddgraph). The results of a data-flow analysis are mapped on the ddgraph for testing requirements and the test suite minimization is treated as the problem of finding the minimal spanning set. However, these approaches are primarily based on a code-level structural coverage and exploit only the implications among coverage requirements. Some have presented a new test suite reduction greedy approach, called the Delayed-Greedy technique, which iteratively exploits implications among test cases and requirements to prune the minimized test suite. This approach has been extended by retaining test cases which improve a fault-detection capability of the test suite. The approach produces bigger solutions, but with higher fault detection effectiveness. The shortcoming of all these approaches is that they compute approximated solutions and cannot offer any guaranty on the minimality of the test suite.

Exact approaches. An exact technique able to compute true optimal solutions to the test suite reduction problem based on ILP and a bi-criteria decision making analysis may be used. Similarly, another ILP-based approach was proposed, called MINTS, that considers several criteria in test suite reduction. This technique extends the exact technique by comparing different heuristics for a multi-criteria ILP formulation, such as weighted sum, prioritized optimization or hybridation. Nevertheless, the general limitation of ILP is the early exponential time blow-up to determine the true minimum, which exposes the technique to serious limitations even for small problems. In the context of software product lines optimization, an alternative approach has been proposed that uses Boolean Satisfability (SAT) or Satisfability Modulo Theories (SMT) solvers. The general principle of this approach is to encode the test suite reduction problem as a Boolean formula that can be evaluated and manipulated by the SAT or SMT solver. The considerable recent improvements made on these solvers makes this approach very promising. Similarly, other similar approaches encode the problem with Binary Decision Diagrams and use traditional transformation algorithms to find an optimal order over the variables to reduce the test suite. To compromise the shortcomings of ILP, some have proposed a degraded ILP approach, called DILP, that calculates a lower bound of a minimum test suite and then searches a small test suite close to the lower bound. Still others have proposed other ILP-based approaches to test suite reduction that allows setting upper limits on the loss of fault-detection capability in test suite reduction. Further, some references have proposed using search-based algorithms to find optimal solutions of a multi-objective test suite optimization problem. By comparing several algorithms for, for example, five different criteria, they observe that random-weighted multi-objective optimization is the most efficient approach. However, this approach assigns weights at random, meaning actually that no priority can be established between the criteria.

The test suite reduction approach presented herein provides a system and method for optimal test suite reduction without the drawback of currently known methods and systems.

### SUMMARY OF THE INVENTION

The present invention advantageously provides a method and system for reducing the size of a test suite while preserving its overall quality.

A trend in software testing is reducing the size of a test suite while preserving its overall quality. Given a test suite and a set of requirements covered by the suite, test suite reduction aims at selecting a subset of test cases that cover the same set of requirements. Even though this problem has received considerable attention, finding the smallest subset of test cases is still challenging and commonly-used approaches address this problem only with approximated solutions. When executing a single test case requires much manual effort (e.g., hours of preparation), finding the minimal subset is needed to reduce the testing costs.

A new method for test suite reduction is discussed herein, which is based on the computation of network maximum flows (a search among network maximum flows). From a given test suite and test requirements covered by the suite, the method, in an embodiment of the invention, forms a bipartite graph with special capacity constraints and searches for maximum flows in its corresponding flow network. In another embodiment of the invention, from a given test suite and the requirements covered by the suite, the method forms a flow network (with specific constraints) that is then traversed to find its maximum flows. In another embodiment of the invention, the method leverages the Ford-Fulkerson method to compute the maximum flows and constraint programming techniques to search among the optimal flows. The method presented herein is the first approach that uses network maximum flows to address the test suite reduction problem. The method is an exact method that computes a minimum-sized test suite, preserving the coverage of requirements.

The test suite reduction approach in accordance with the invention addresses all three drawbacks of the conventional approaches mentioned above. It is an exact method that finds a true minimum number of test cases covering the same set of requirements as the original test suite. The method is quick for medium-size problems. In particular, for the problems consisting of 3000 requirements and 500 test cases, it computes the minimum-cardinality subset in less than a minute on a standard machine. In addition to test suite reduction retaining requirements coverage, the method can handle multiple criteria in reduction, for example, test execution cost or fault-detection capability.

To evaluate the method, a prototype implementation has been developed using the SICStus clpfd library and a comparative analysis has been conducted of the time needed to reduce test suites and the size of the reduced suites, for 2005 test suite reduction problems. In this experimental study, the method is compared with a simple greedy model and a non-optimized ILP model, which are implemented using the classical description in the literature. The experimental results show that the method outperforms a non-optimized implementation of the Integer Linear Programming approach by 15-3000 times in terms of the time needed to find an optimal solution, and a simple greedy approach by 5-15% in terms of the size of reduced test suite.

According to one embodiment of the disclosure, a method of test suite reduction is provided. The method includes obtaining a plurality of test requirements and a plurality of test cases, forming a flow network based on the test requirements and the plurality of test cases, and evaluating the flow network to find one or more maximum flows, wherein the one or more maximum flows represent a subset of test cases covering the plurality of test requirements.

According to one embodiment of this aspect, the method further includes selecting from the one or more maximum flows, at least one minimal-cardinality subset of test cases. According to another embodiment of this aspect, the selecting is based on searching the one or more maximum flows using a branch-and-bound algorithm. According to another embodiment of this aspect, the selecting is based on multiple objectives, where the multiple objectives could include one or more of: fault detection capabilities, test execution time, and code coverage.

According to another embodiment of this aspect, the method further includes generating a bipartite graph based on the plurality of test requirements and the plurality of test cases, where the flow network is formed from the bipartite graph. According to another embodiment of this aspect, the bipartite graph is augmented with a source node S and a destination node D. According to another embodiment of this aspect, for a requirement in the plurality of test requirements there is an arc in the bipartite graph from the source node S to the requirement. According to another embodiment of this aspect, the arc is associated with a capacity of 1.

According to another embodiment of this aspect, for a requirement in the plurality of requirements there is an arc in the bipartite graph from the requirement to a test case selected from the plurality of test cases if the requirement is covered by the selected test case. According to another embodiment of this aspect, the arc is associated with a capacity of 1. According to another embodiment of this aspect, for a test case in the plurality of test cases there is a final arc in the bipartite graph from the test case to the destination node D. According to another embodiment of this aspect, the final arc from the test case to the destination node D is associated with a capacity of a sum of the capacities of arcs from all test requirements that are covered by the test case.

According to another embodiment of this aspect, the selected minimal-cardinality subset is represented by a maximum-cardinality subset of critical branches with zero flow in the flow network, the critical branches being final arcs of the bipartite graph. According to another embodiment of this aspect, the method further includes encoding relations between the plurality of test cases and the plurality of test requirement as domain constraints in a constraint solver. According to another embodiment of this aspect, the evaluating is based on searching for the one or more maximum flows using the constraint solver.

According to another embodiment of this aspect, the method further includes removing test requirements that are covered by a single test case and including the single test case in a solution set of the constraint solver. According to another embodiment of this aspect, the method further includes selecting from the maximum flow at least one minimal-cardinality subset of test cases, wherein the selecting is made using the constraint solver. According to another embodiment of this aspect, the method further includes controlling an execution time of the constraint solver. According to another embodiment of this aspect, the method further includes initializing a residual graph with zero flow, and when there is an augmenting path in the residual graph, increasing a flow along the augmenting path until the one or more maximum flows are found.

According to another embodiment of the disclosure, a system for reducing a size of a test suite is provided. The system includes at least one processor, and a memory including instructions that, when executed by the at least one processor, cause the system to obtain a plurality of test requirements and a plurality of test cases, form a flow network based on the test requirements and the plurality of test cases, and evaluate the flow network to find one or more maximum flows, wherein the one or more maximum flows represent subsets of test cases covering the plurality of test requirements. According to another embodiment of this aspect, the instructions when executed further cause the system to select from the maximum flow, at least one minimal-cardinality subset of test cases. According to another embodiment of this aspect, the selecting is based on searching the maximum flow using a branch-and-bound algorithm. According to another embodiment of this aspect, the selecting is based on multiple objectives. According to another embodiment of this aspect, the multiple objectives include one or more of: fault detection capabilities, test execution time, and code coverage. Further, the instructions when executed further cause the system to generate a bipartite graph based on the plurality of test requirements and the plurality of test cases, and wherein the flow network is formed from the bipartite graph.

According to another embodiment of the disclosure, a computer readable storage medium storing executable instructions for reducing a size of a test suite is provided. The instructions, when executed by a processor, cause the processor to obtain a plurality of test requirements and a plurality of test cases, form a flow network based on the test requirements and the plurality of test cases, and evaluate the flow network to find one or more maximum flows, wherein the one or more maximum flows represent subsets of test cases covering the plurality of test requirement.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a bipartite graph for test suite reduction;

FIG. 2 shows a flow network with three test cases covering seven test requirements;

FIG. 3 shows feasible solutions (maximum flows in a graph) for the Minimum-Cardinality Subset (MCS) problem with three test cases covering seven test requirements;

FIG. 4 shows a graph showing the relative difference in time between the method described herein and the greedy model;

FIG. 5 shows a graph showing the distribution of the percentage of test suite reduction for the method described herein (left box) and the greedy model (right box);

FIG. 6 shows a comparison of time to compute solutions for the method described herein, the ILP, and the greedy model;

FIG. 7 shows the percentage of a test-suite size reduction for the method described herein, the ILP, and the greedy model; and

FIG. 8 shows a flowchart illustrating an exemplary embodiment of the test suite reduction method described herein.

### DETAILED DESCRIPTION OF THE INVENTION

### 1. Background and Notations

### 1.1. Test Suite Reduction

Test suite reduction aims to decrease the overall number of test cases while retaining the coverage of the original test suite. A reduced test suite covering the same test requirements as the original suite, but not necessarily of the smallest possible size, is called a representative test suite. An optimal test suite reduction aims to determine the representative test suite consisting only of essential test cases, known as a minimum-cardinality subset. If any of the test cases from an optimal representative test suite were removed, the test suite would not satisfy all test requirements. RTS is used herein to refer to a Representative Test Suite and MCS is used herein to refer to a Minimum-Cardinality Subset, i.e., an optimal RTS. Note that an MCS is not necessarily unique for a given test suite reduction problem.

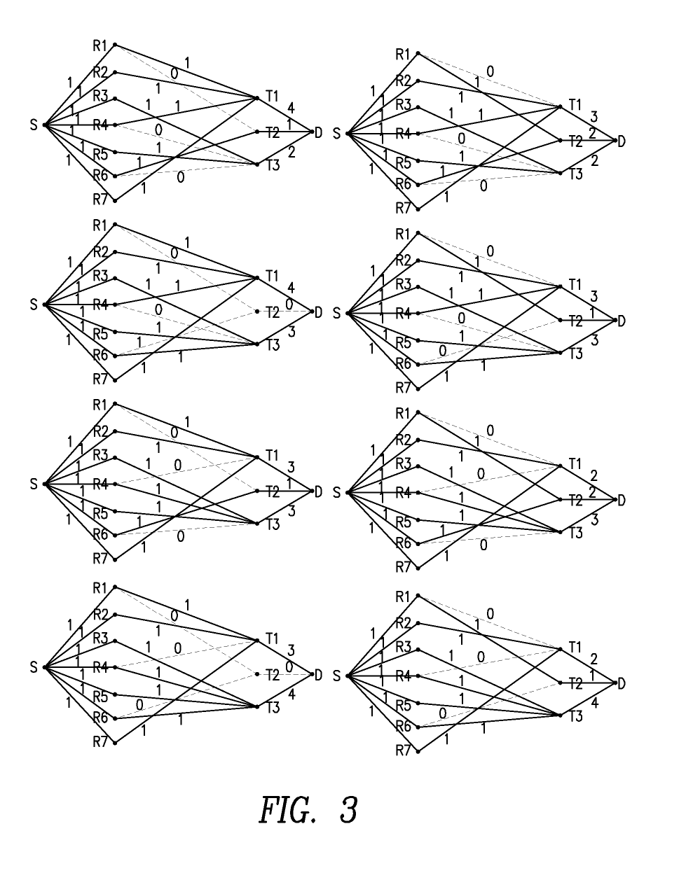

Formally, a test suite reduction problem is defined by an initial test suite T={T1, . . . , Tm}, a set of test requirements R={R1, . . . , Rn} and a function cov: R→2^{T} mapping each requirement to the subset corresponding to its covering test cases. One can suppose that each requirement is covered by at least one test case, i.e., ∀i ∈ {1, . . . , n}, cov(Rᵢ)≠Ø. An example with three test cases and seven test requirements is given in Table 1, where “1” denotes that the requirement is covered by the corresponding test case, and “0” denotes the opposite (also shown in FIG. 3). Given T, R and cov, an RTS T′ is a test suite T′ ⊂ T such that ∀i, ∃t ∈ T′ and t ∈ cov(Rᵢ), meaning that each requirement is covered by at least one test case from T′. If Card(S) denotes the cardinality of the set S, an RTS T′ such that card(T′) is minimal, is an MCS.

TABLE 1
Coverage of test requirements by test cases.

| | R1 | R2 | R3 | R4 | R5 | R6 | R7 |
|---|---|---|---|---|---|---|---|
| T1 | 1 | 1 | 0 | 1 | 0 | 0 | 1 |
| T2 | 1 | 0 | 0 | 0 | 0 | 1 | 0 |
| T3 | 0 | 0 | 1 | 1 | 1 | 1 | 0 |

### 1.2. Flow Network

A flow network is an oriented graph G=(V,A) where each arc(u,v) ∈ A is associated with a capacity c(u,v)≧0. Every flow network contains two special vertices: the source s and the sink t, and for each v ∈ V there exists a path from s to t traversing v (connexity). A feasible flow (or flow in short) in G is a function f:V×V→R that associates to each arc(u,v) a real value f(u,v) such that the following laws are satisfied:

1. Capacity Constraints:

∀(u,v) ∈ A, 0≦f(u,v)≦c(u,v)

2. Flow Conservation Law:

∀u ∈ V \ {s,t}, Σ_{v∈V}f(v,u)=Σ_{w∈V}f(u,w)

Provided that there is no incoming arc to the source s, the value of a flow, noted |f| is equal to Σ_{v∈V}f(s,v). The maximum flow problem aims at finding a flow f* with a maximum value. In general, there are several flows with maximum value and computing a maximum flow is done using the Ford-Fulkerson method. The Ford-Fulkerson method is based on the residual graph G_{f} associated with a given flow f, and the computation of augmenting paths. In brief, the method iteratively increases the value of a given feasible flow by finding an augmenting path within the residual graph associated with this flow. The key-point of the method is exhibited by the following procedure:

Input: G; s; t
Output: Maximum flow f*
Initialize f to 0;
while There exists an augmenting path p in the residual network G_{f} do

Increase flow f along p;

end
return f

There are several variants of this method, e.g., the Edmonds-Karp algorithm, with different complexities. For the test suite reduction approach presented herein, any of these algorithms can be employed. Finally, an important result of the network flow theory for the approach presented herein is the following: For any flow network, if the capacities are integers, then any flow value (including the maximum) is an integer. This also applies to the flow values on arcs. This property is crucial when encoding a test suite reduction, because it explains why every computation can be performed on variables of integer type.

### 1.3. Bipartite Graph

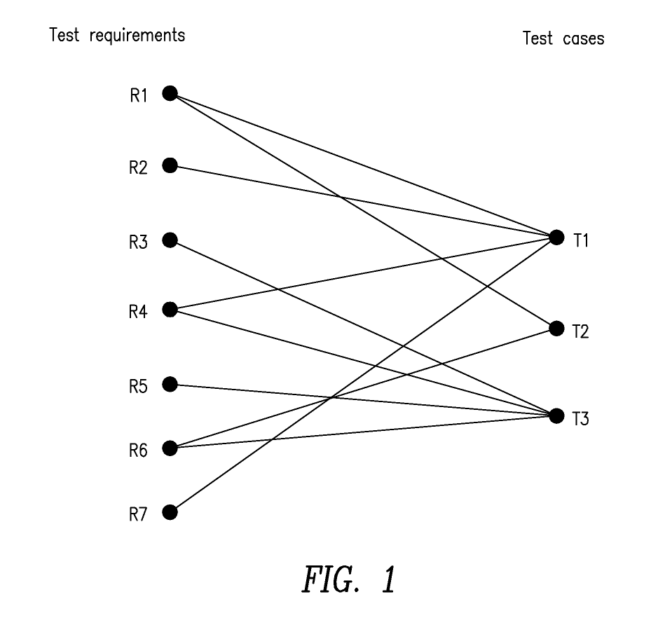

A bipartite graph is a graph G=(V,A) where V is partitioned in two subsets: L and R (i.e., L ∪ R=V and L ∩ R=Ø), with arcs between L and R only. FIG. 1 illustrates a bipartite graph for the test suite reduction problem in Table 1.

### 2. The Test Suite Reduction Approach According to the Invention

In the test suite reduction approach described herein, a test suite reduction is encoded as a network maximum flow problem.

2.1. Encoding Test Suite Reduction with a Flow Network

A test suite reduction can be encoded with a bipartite graph G=(V,A) augmented with a source node S and a destination node D. Formally speaking, V=R ∪ T ∪ {S,D} and there is an arc(u,v), u ∈ R, v ∈ T iff v ∈ cov(u). For each arc(u,v) in the bipartite graph, an integer capacity c(u,v) is added as follows:

1. For any arc(u,v) from S to Rᵢ, add c(u,v)=1;

2. For any arc(u,v) from Rᵢ to Tⱼ, add c(u,v)=1;

3. For any arc(u,v) from Tⱼ to D, add c(u,v)=Σ_{w∈T}c(w,u).

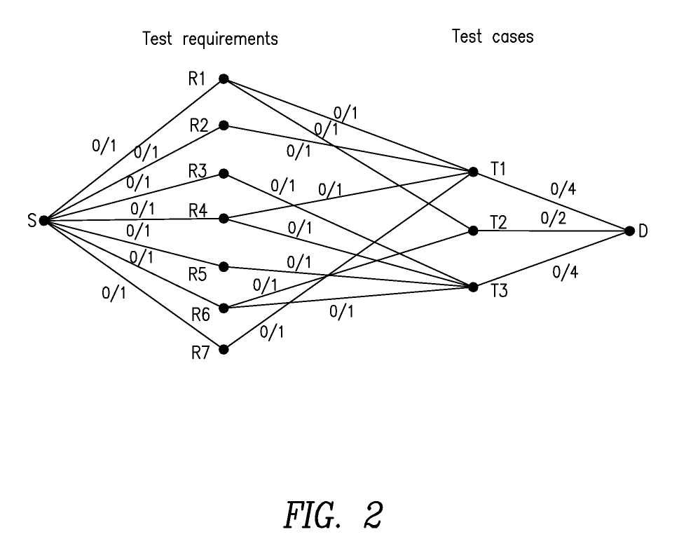

For any maximum flow in G, Item 1 enforces the coverage of all requirements, Item 2 encodes the values of the cov function, while Item 3 encodes the various possible selections of test cases. FIG. 2 illustrates the network flow G associated with the test suite reduction problem in Table 1.

### 2.2. Finding a Representative Test Suite Using Maximum Flows

The following theorem is essential to link a test suite reduction to a network maximum flow:
Theorem 1: Let G be the network flow associated with a test suite reduction problem. A representative test suite (RTS) is equivalent to a maximum flow in G.

To demonstrate the above theorem, the following three properties can be proven to be equivalent:

1. f is a maximum flow in G;

2. |f|=n, where n is the number of requirements;

3. T, composed of the vertices t such that f(t,D)≠0, is an RTS.

### Proof:

(1==>2) For any flow f, ∀i ∈ {1, . . . , n}, f(S,Rᵢ)≦c(S,Rᵢ)=1. Therefore, |f|≦n. Proving that there exists a feasible flow f of value n would show that |f|≧n as well. Consider the maximum flow f where each ∀u ∈ R,f(S,u)=1. It is a feasible flow because each requirement is covered by at least one test case, and thus the flow conservation law from S to D is preserved, i.e., Σ_{w∈T}f(w,D)=Σ_{u∈R}f (u,t)=Σ_{u∈R}f (S,u). Accordingly, all the capacity constraints are satisfied. Therefore, |f|=n.

(2==>3) If |f|=n then Σ_{w∈T}f (w,D)=n and T is the set of test cases t for which f(t,D)≠0.

(3==>1) Consider the flow f associated with the subset T of test cases t for which f(t,D)≠0. One can prove that f is actually a maximum flow. As T is an RTS, it means that all requirements are covered. Thus, Σ_{t∈T}f (r,T)=Σ_{u∈R}f(S,u)≦Σ_{u∈R}c(S,u)=n, where n is the number of requirements. As f has reached all the capacity values on arcs from the source S to R, then f is maximum.

As the result, for any maximum flow f, the subset of test cases T′⊂ T such that f*(t,D)≠0, is an RTS, what concludes the proof of Theorem 1.

FIG. 2 illustrates a test reduction problem encoded as an augmented bipartite graph G. G is directed from S to D, with l/c values assigned to all arcs. In FIG. 2, l=0 for all arcs, meaning that the flow is feasible but not maximum. Maximum flows, as shown in FIG. 2 correspond to various solutions of the RTS problem. More precisely, the maximum flow values on arcs give the RTS, i.e., the subset of a test suite that covers all test requirements. For example, a maximum flow <S-R1-T1-D;S-R2-T1-D;S-R3-T3-D;S-R4-T1-D;S-R5-T3-D;S-R6-T2-D;S-R7-T1-D> is associated with the set {T1,T2,T3} because none of the flow values on arc from Tᵢ to D are null. This example solution is useless as it does not provide any reduction of the original test suite. However, as illustrated in FIG. 3, there are eight possible maximum flows in G and two of them exhibit optimal reduction, i.e., consist of only two test cases. A goal is then to search among maximum flows for the flow that maximizes the number of zeros on the arcs from T to D.

### 2.3. Finding a Minimal-Cardinality Subset

In this section, a proof is provided for a theorem that links the Minimum-Cardinality Subset to the search among maximum network flows. Also, the practical labeling search procedure used to search among maximum flows is described.

Let the critical branches be the final arcs of the bipartite graph, namely the <Tᵢ-D>arcs, and critical values the values of the flow on these arcs. For any flow f, let q₁^{f}, . . . , qₘ^{f} be the critical values associated to f on m critical branches, and let n be the number of requirements. Proved in the previous section, the following property holds: For any maximum flow f*, Σ_{i∈1..m}qᵢ^{f}*=n. This property is crucial to prove the following theorem, which contains the essence of the test suite reduction approach described herein:
Theorem 2: A maximum flow f* such that the number of critical branches with zero flow is maximum, represents a Minimal-Cardinality Subset (MCS), and conversely.

### Proof:

Theorem 2 states that if Card_{i∈1..m}({qᵢ^{f}*s.t.qᵢ^{f}*=0}) is maximum then the RTS corresponding to f* forms the MCS. According to the above mentioned property, Σ_{i∈1..m}qᵢ^{f}*=n. Therefore, by duality, it means that Card_{i∈1..m}({qᵢ^{f}*s. t. qᵢ^{f}*≠0}) is the minimum. Then, considering the RTS T associated to f*, one gets that T is of minimum cardinality, and is thus the MCS. Conversely, there is no smaller set T included in the MCS and, therefore, the number of zero flows in the maximum flow f* is maximized.

Theorem 2 ensures both the correctness and completeness of the method by bridging two separate domains, namely Software Testing and Network Flow Theory. However, the Theorem is not constructive, as it says nothing about how to find an MCS. Actually, finding an MCS requires searching among maximum flows. Conveniently, the Ford-Fulkerson method can be combined with a labeling procedure, which is an incremental assignment process of values to variables. The overall search space formed by the various maximum flows can be explored through the assignment one-by-one of the critical values of the bipartite graph. In the example in FIG. 1, labeling variables T1,T2,T3 enables exploring all the maximum flows in a flow network. One way to explore the search space is to assign all variables at once, e.g., searching for the solutions with three values assigned to T1,T2,T3. Another more subtle way is to start by assigning a value to one of the variables and propagating this assignment throughout the flow network, by backtracking until the last assignment, if a contradiction is found, and repeat the assignment process until all variables are assigned. In the example, giving value 0 to T1 would lead to contradiction, because the requirement R2 cannot be covered any more. In fact, depending on the order of critical branches, the labeling procedure selects a branch and a value, propagates the value through the flow network and evaluates the number of zeros in the remaining critical branches. If the number of zeros is less than the current value, the procedure backtracks to the branch/value selection and makes another choice. Propagating a choice through the flow network means pushing values for the other flows, depending on the initial choice. This process is well-known in Discrete Optimization under the terminology branch-and-bound.

### 2.4. Multi-Objective Test Suite Reduction

In a basic form, test suite reduction aims to retain the requirements coverage of the original test suite while reducing the overall number of test cases. However, there is often a need in practice to consider multiple objectives in test reduction, such as fault detection capabilities, test execution time or code coverage, which can all be considered as alternative priorities. In an embodiment of the invention, the method supports multi-objective test suite reduction, with test requirements coverage as a primary objective and test fault-detection data as a secondary objective, similarly to the idea that the authors have explored previously. After all MCSs have been computed, secondary objectives are considered to propose the solution with the best fault detection rate. This is handled by exploring the capacity constraints that encode priorities instead of values “1” in the bipartite graph encoding the test suite reduction. Leveraging the cost-based solving procedures, MCSs are considered one-by-one to evaluate their fault detection capabilities (or alternatively, test execution time, code coverage, or other priorities relevant for users). In this way, the method provides an MCS that is optimal with respect to test suite size, taking into account fault-detection capability. A drawback of this approach is that well-balanced solutions (not necessarily optimal in terms of test suite size) may not be found by the method. On the other hand, the advantage is that it encodes a simple and efficient priority-based scheme for addressing multi-objective optimization.

### 2.5. Complexity Analysis

The Ford-Fulkerson method is available in several variations, i.e., algorithms with distinct complexity classes. In an embodiment of the invention, the algorithm can be a classical one based on the residual graph and augmented paths. Its asymptotic time-complexity to compute the maximum flow is known to be O(a*|f|) in the worst case, where a is the number of arcs in the bipartite graph and |f| is the flow value. In the context of RTS, one already knows that |f| is equal to the number of requirements. Therefore, the complexity is O(a*n) where n is the number of requirements. However, in this embodiment of the invention, the “costly ” part of the method is the search among maximum flows. This procedure is exponential in time as a backtracking procedure may explore all the possible values for critical branches in the worst case. As there are as many critical branches as test cases, the worst-case complexity of this labeling process is O(n^{m}), where m is the number of test cases. Note that, as the Ford-Fulkerson is launched every time a choice on a critical branch and critical value is made, the overall complexity is O(a*n^{m+1}). This result is not surprising as finding an MCS is an NP-complete problem.

Although the method may lead to a combinatorial explosion in the worst case, experiments show that it scales up to problems of industrial size. Complexity analysis of other approaches used for solving the same problem indicates that the ILP approach in the worst-case is similarly exponential in the number of test cases m. This problem can however be approximated by polynomial algorithms, using greedy approaches. The greedy approach implemented for the purpose of comparative evaluation is of complexity O(m*log(m)+2*m*n). This implementation is described in detail in the next section.

### 3. An Example Implementation of the Test Suite Reduction Method

In an example embodiment of the invention, the test suite reduction is a tool implemented in SICStus Prolog, using the clpfd library. This library embeds the constraint solver over finite domains variables, i.e., variables that have a domain of finite integer values. Using this solver allows to encode the relations between test cases and requirements directly as domain constraints. For example, the bipartite graph in FIG. 1 is encoded in the method as:
R1 ∈ { 1,2}, R2=1, R3=3, R4 ∈ {1,3}, R5=3, R6 ∈ {2,3}, R7=1.
   Using this encoding automatically removes test requirements that are covered by a single test case (e.g., R2 is assigned to 1) and includes the corresponding test case in the solution set (e.g., T1). In this example, the relation is composed of only three requirement variables, because R2,R3,R5 and R7 are already assigned. This is a simple encoding of the problem using finite domain constraints, but still very efficient.

In an example embodiment of the invention, the Ford-Fulkerson algorithm is interfaced with the method through the filtering procedure of the global-cardinality constraint. This constraint is denoted
global_cardinality([X1, . . . , Xd], [K1-V1, . . . , Kn-Vn])
   or gcc in short. In this formulation, the Xi are integers or domain variables, and [K1-V1, . . . , Kn-Vn] is a list of pairs where each key Ki is a unique integer and Vi is a domain variable or an integer. The constraint enforces that Xi is equal to some key and for each pair Ki-Vi, exactly Vi elements of [X1, . . . , Xd] are equal to Ki. Referring to Section 2, Vi represents a critical value of the critical branch in the corresponding bipartite graph. Therefore, encoding the search for a maximum flow in a bipartite graph can be realized by the following call:
gcc([R1, . . . , Rn], [1-V1, . . . m-Vm]),
   where Ri represents the variables associated to the test requirements and Vi represents the critical values in the maximum flow solution set. For example, the problem in FIG. 1 is encoded using the following call:
gcc([R1,1,3,R4,3,R6,1], [1-V1,2-V2,3-V3]),
where V1 ∈ {0, . . , 4}, V2 ∈{0,1,2},V3 ∈ {0, . . , 4}.

In addition to the gcc constraint, a branch-and-bound procedure can be implemented in clpfd. The objective function is the number of zeros in the list [V1, . . . , Vm], so that maximizing this function reduces to the minimization of the test suite. This procedure is combined with a labeling process over the Vi (i.e., the critical values), which incrementally assigns the values for the Vi in specific order. Several heuristics control which branch and value should be selected first. Each time a Vi is selected for assignment, the objective function is evaluated and its current value recorded. When selecting other values for the same Vi or a different variable, if the number of zeros is lower than the current recorded number, then all the remaining search space to be explored with this value is just discarded. For evaluating the objective function in the method, a finite domain variable can be maintained that is bounded to the number of zeros.

This branch-and-bound procedure is time-aware, also known as an anytime algorithm, meaning that a given contract of time can be allocated beforehand, for example by a user. In fact, most of the time a candidate optimum is proposed very quickly and the rest of the time is spent proving that this is actually the optimum. Therefore, allocating a contract of time permits the obtaining of an optimum, and control of the time allocated to the proof. This is particularly useful to control the search when several problems have to be solved or very large instances are considered.

In an embodiment of the invention, specific input/output formats can be defined by building appropriate data structures. The management of bipartite graph can be handled directly by the filtering algorithm of the gcc constraint.

### 4. Experimental Evaluation

In the following, an experimental study performed to evaluate an example implementation of the method is presented. The first part of the study shows time effectiveness of the method in computing an MCS for a large set of test suite reduction problems. Second, the study shows how well the method performs in terms of the size of reduced test suites. The method is compared with implementations of an ILP model and a simple greedy approach, using descriptions from the literature, i.e. they do not compute the global minimum of the problem, although they perform well in terms of execution time.

### 4.1. Experiment Subjects

The method has been evaluated on a set of 2000 randomly generated TSR problems, specified as a test suite with a set of test requirements and an association defining which test cases satisfy which test requirements. The size of the test suites in the TSR problems ranged from 20 to 1000 test cases, and the number of test requirements from 20 to 5000 requirements. The problems were generated as 20 sets of 100 problems each. The problems in a set have the same test suite size and the same number of test requirements satisfied by the suite. They differ in the number of requirements satisfied by each test case and their assignment to a test case. An important aspect to consider when generating TSR problems is the number of test requirements associated with one test case. This property of a TSR problem affects the time performance of the TSR process. To take into account this factor and evaluate different TSR problems, the number of test requirements associated with one test case in the experimental subjects varies from 1 to the total number of test requirements in a test suite. Table 2 provides summary information about the test subjects used in the experiment.

TABLE 2
Experiment subjects: ES is a set of 100 test suite reduction problems that have the
same test suite size and the same number of test requirements satisfied by the suite.

| | ES1 | ES2 | ES3 | ES4 | ES5 | ES6 | ES7 | ES8 | ES9 | ES10 |
|---|---|---|---|---|---|---|---|---|---|---|
| Number of test | 50 | 250 | 350 | 500 | 200 | 50 | 100 | 20 | 50 | 100 |
| requirements | | | | | | | | | | |
| Number of | 20 | 20 | 30 | 30 | 40 | 50 | 50 | 100 | 300 | 500 |
| test cases | | | | | | | | | | |
| | ES11 | ES12 | ES13 | ES14 | ES15 | ES16 | ES17 | ES18 | ES19 | ES20 |
| Number of test | 400 | 400 | 450 | 500 | 500 | 1000 | 2000 | 3000 | 4000 | 5000 |
| requirements | | | | | | | | | | |
| Number of | 200 | 1000 | 300 | 250 | 300 | 500 | 200 | 500 | 1000 | 1000 |
| test cases | | | | | | | | | | |

Supplementary to the evaluation on synthetic subjects, the method has been assessed on five subjects representing industrial test suites. These subjects were selected as the most representative suites from the test database, which contains several tens of suites, mainly similar in size. The test subjects vary from 30 to 59 requirements and from 90 to 107 test cases, with three to 11 requirements covered by one test case in average and a standard deviation from 1.1 to 1.5. The suites in a test database are specified manually and as they evolve over time, very often they contain test cases covering the requirements covered by other test cases in the suite. To reduce testing effort and support cost-effective testing, such test suites need to be reduced to their minimal size. Table 3 summarizes information about the real subjects.

TABLE 3
Real experiment subjects with an average number of test requirements
covered by a test case (rounded to nearest) and a standard deviation.

| | Res1 | Res2 | Res3 | Res4 | Res5 |
|---|---|---|---|---|---|
| Num. of test req. | 59 | 59 | 50 | 35 | 30 |
| Num. of test cases | 107 | 90 | 93 | 100 | 100 |
| Coverage | 6 | 7 | 3 | 5 | 11 |
| Deviation | 1.2 | 1.2 | 1.5 | 1.1 | 1.2 |

### 4.2. Experiment Setup

The goal of the study was to evaluate the effectiveness of the example implementation of the method in obtaining the MCS for the considered experiment subjects in terms of (1) time to compute the MCS and (2) size of the reduced test suite. To do this, the example implemented method was compared with the ILP and the greedy approaches. First, the time taken by the method was compared with the time required by the ILP and greedy approaches. Next, the size of the reduced test suite obtained by the method was compared with the size of the suite given by the ILP and greedy approaches.

For the purpose of evaluation, the ILP model was implemented using clpq, a linear constraint solver over the rationals. The solver is based on classical techniques such as the Fourier elimination, the simplex algorithm and the branch-and-bound procedure for integer problems. The ILP model for optimal test suite reduction encodes the selection of each test case with a 0-1 variable and each association of a requirement to a test case with a linear inequality. Minimizing the number of test cases requires minimizing the linear sum expressions over all 0-1 variables. For the same purpose, a greedy approach was implemented as follows: test cases are first sorted by increasing order of requirements coverage using quicksort. Next, an iterative procedure selects one by one a test case until all the requirements are covered at least once.

The experimental study was conducted as follows: first, for each test subject, the method was run, the ILP and greedy models and measured the time to compute an MCS; second, the size of the reduced test suites computed by the three approaches was measured. The experiments were run on Intel Core i7-2929XM CPU at 2.5 GHz with 16 GB RAM.

### 4.3. Results and Analysis

This section presents and discusses the results of the experimental study, in order to find out whether the method presented herein is time-effective in computing an MCS compared to the ILP and greedy approaches, and whether the method achieves better test suite reduction rate compared to the ILP and greedy approaches.

### 4.3.1. Time Effectiveness

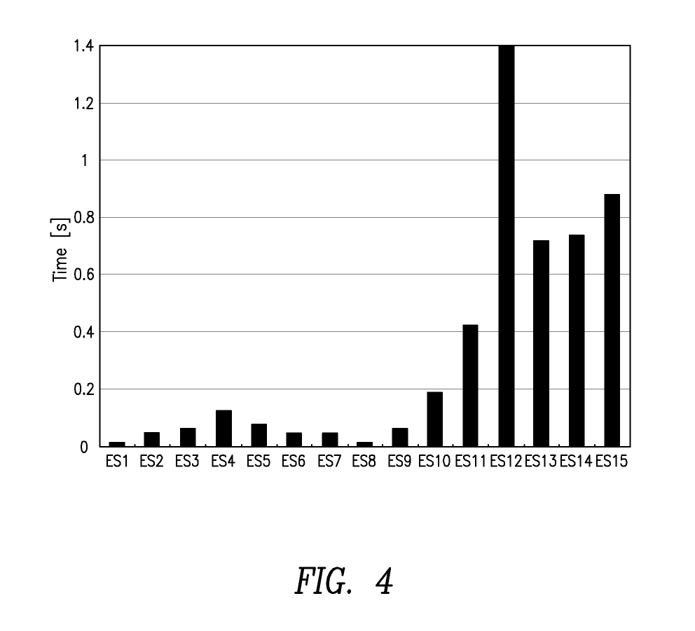

To find out whether the method presented herein is time-effective in computing an MCScompared to the ILP and greedy approaches, the time taken by the example implementation of the method, the ILP model and greedy model was analyzed to compute the MCS for 2000 experimental subjects in Table 2. The data indicated that the method and the greedy approach were able to find the solution for all considered subjects, while the ILP approach was not able to compute the solution for more complex problems ES9-ES20 in reasonable time. Each box shows the distribution of the running time for the set of 100 subjects. The subjects were grouped in eight groups by the number of test cases and the number of test requirements per test case. Each ES group is represented with three boxes: the left box shows the time taken by the method, the middle box shows the time for the ILP model and the right box shows the time taken by the greedy model. The results showed that the performance of the method and the greedy approach is fairly similar across all subjects. The method took in average between 20% and 30% more time than the greedy approach. ER, and between 0.015 and 0.0178 seconds, with an average time of 0.03 seconds for the greedy model). However, the ILP model exhibits a significant increase in running time as the size of the problems grows. In particular, for the simplest problems ES1 and ES2, the ILP model required up to 16 seconds in the worst case to find the MCS, while the method took 0.047 seconds in the worst case for the same problems. For the ES6, the worst-case running time for the ILP model was 465 seconds, while for ES7 it went up to 700 seconds, compared to 1.504 seconds in a worst case for the method for the same problems. For the complex test suite reduction problems ES9-ES20, the ILP was not able to compute the solution after more than 700 seconds of running. On the contrary, the method was very quick in solving those problems, it reduced the problems containing 3000 requirements covered by the set of 500 test cases in less than one minute on average. FIG. 4 shows relative difference between the time taken by the method and the greedy model on average, for 15 sets consisting of 100 randomly generated subjects. The results are in favor of the greedy model, showing that the greedy model consistently outperforms the method in terms of time.

The difference in the performance between the method and the ILP model can be explained by the properties of the reduction problem. The experimental results show that the number of test cases in a suite has the largest impact on the ILP model running time. As this number increases, the overall search space, which is a T-dimension convex polyhedron, where T is the number of test cases, increases as well. On the contrary, the method is less affected by the increase of a number of test cases in a suite, as it encodes the coverage relation using a sparse representation (e.g., R₁ is covered by T₂ and T₅ is encoded in the method as variable R₁ has domain {2,5}, while it is encoded as 0*B₁+1*B₂+0*B₃+0*B₄+1*B₅+ . . . ≧1 where B₁,B₂, . . . are boolean variables in the ILP model). For E4, E5 and E7 subjects, a poor performance of the ILP model is due to the combination of bigger test suites and a larger number of test requirements.

In summary, the results of the experiment show that the method consistently provides faster test suite reduction comparing to the ILP model. For the subjects E1-E8, the method was able to compute the MCS for all subjects in less than 1.504 seconds, while the ILP model took ˜700 seconds in the worst case. In particular, the method showed to outperform the ILP model in terms of the time needed to find the solution by 15-3000 times. These results show that the method is time-efficient approach to test suite reduction.

### 4.3.2. Size of the Reduced Test Suites

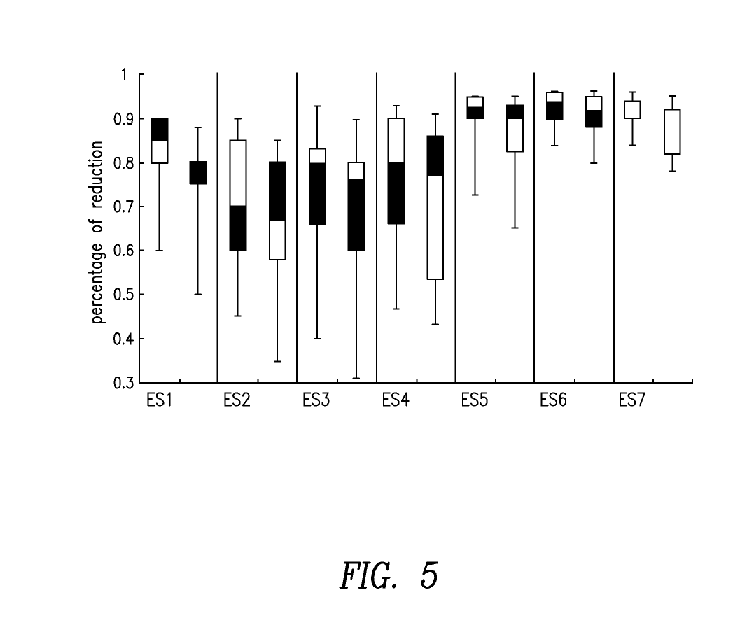

To find out whether the method achieves a better test suite reduction rate compared to the ILP and greedy approaches, the reduction rate for an example implementation of the method, the ILP and greedy models were analyzed, as the number of test cases eliminated from the test suite were being reduced. The reduction rate of these three approaches were compared across 2000 experiment subjects (given in Table 2). The results showed that the method and the ILP model achieved identical reduction rate for the considered subjects, while the greedy approach performed worse. FIG. 5 presents the distribution of reduction rate in percentage for seven sets of subjects E1-E7 for the method and the greedy model, in the form of a boxplot. The subjects were grouped in seven groups by the number of test cases and the number of test requirements per test case. In the boxplot, each ES group is represented with two boxes: the left box illustrates the percentage of reduction rate for the method and the right box illustrates the same for the greedy model. As the results show, the difference in the reduction rate between the method and the greedy approach is consistent across the considered experiment subjects and is within the range of 5% to 15%, to the advantage of the method in accordance to the invention. It demonstrates that the method is effective in reducing the test suites, producing the size-equivalent solutions as the ILP model and consistently smaller solutions than the greedy model.

### 4.3.3. Real Use Cases

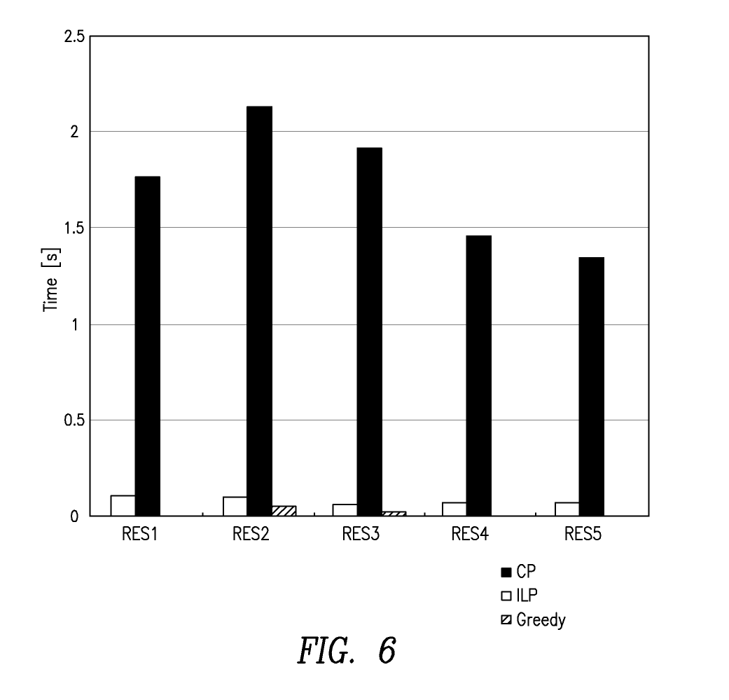

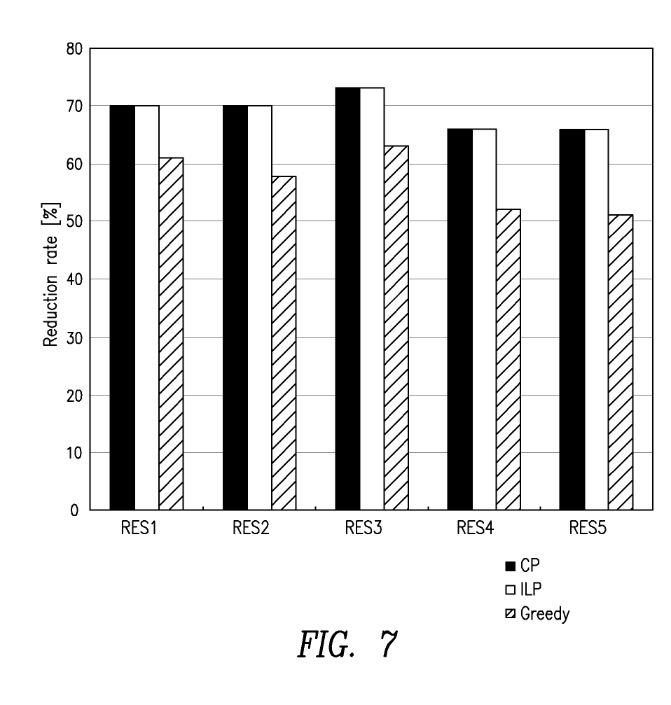

Similar performance of the method has been observed compared to the ILP and greedy models when applied in real uses cases, as when applied to the synthetic subjects. In terms of time needed to find the solution, the method consistently takes 30% more time on average than the greedy model and outperforms the ILP model. The worst-case running time for all five experiment subjects for the method is 0.109 seconds, and for the greedy model and the ILP model 0.05 seconds and 2.132 seconds respectively. Detailed experimental results are presented in FIG. 6. In terms of ability to reduce the size of test suites, the method performs exactly as the ILP model for all five subjects, while the greedy model gives from 10% to 15% bigger solution test suites than the method and the ILP model. FIG. 7 shows the experimental results.

As a non-limiting example, the method may reduce annual configuration effort in software testing and improve software quality.

Software implementing the method may include several informational displays, including diagnostic views, feature coverage, and variability. As shown and described above, the method may be used for time-aware test suite reduction. The test suite reduction may be represented as a network flow problem. In a constraint model with global constraints, maximum flows may be searched using branch-bound (less than 100 Prolog LOC). The time-aware test suite reduction may be based on budgeted test effort (e.g., time). The method according to the invention is more efficient than competitive approaches implemented in tools such as MINTS (Georgia Institute of Technology) or ATAC (Bell Labs). In addition to being offered as downloadable software or software that is installed onto hardware, software implementing the method may also be offered as a non-downloadable web service.

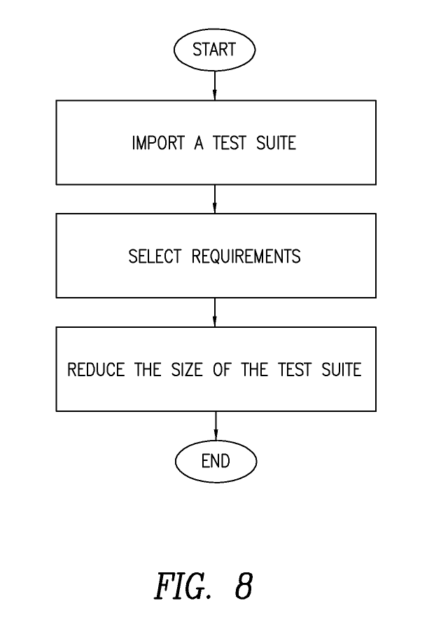

As another non-limiting example, a software tool implementing the method may be realized as an Eclipse RCP (rich client platform) application. Such a software tool may be suited for a continuous integration environment and may be integrated within the software development chain. For example, the software tool may be integrated within the software development chain after test management and test planning tools and before text execution platforms and unit/integration testing tools. Further, software implementing the method may be used as shown in FIG. 8.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of test suite reduction, the method comprising:
obtaining a plurality of test requirements and a plurality of test cases;
forming a flow network based on the test requirements and the plurality of test cases; and
evaluating the flow network to find one or more maximum flows, wherein the one or more maximum flows represent subsets of test cases covering the plurality of test requirements.

2. The method of claim 1, further comprising:
selecting from the one or more maximum flows, at least one minimal-cardinality subset of test cases.

3. The method of claim 2, wherein the selecting is based on searching the one or more maximum flows using a branch-and-bound algorithm.

4. The method of claim 2, wherein the selecting is based on multiple objectives.

5. The method of claim 4, wherein the multiple objectives comprise one or more of: fault detection capabilities, fault severity, fault relevance, test cost, test execution time, and code coverage.

6. The method of claim 1, further comprising:
generating a bipartite graph based on the plurality of test requirements and the plurality of test cases, and wherein the flow network is formed from the bipartite graph.

7. The method of claim 6, wherein the bipartite graph is augmented with a source node S and a destination node D.

8. The method of claim 7, wherein for a requirement in the plurality of test requirements there is an arc in the bipartite graph from the source node S to the requirement.

9. The method of claim 8, wherein the arc is associated with a capacity of 1.

10. The method of claim 6, wherein for a requirement in the plurality of requirements there is an arc in the bipartite graph from the requirement to a test case selected from the plurality of test cases if the requirement is covered by the selected test case.

11. The method of claim 10, wherein the arc is associated with a capacity of 1.

12. The method of claim 7, wherein for a test case in the plurality of test cases there is a final arc in the bipartite graph from the test case to a destination node D.

13. The method of claim 12, wherein the final arc from the test case to the destination node D is associated with a capacity of a sum of the capacities of arcs from all test requirements that are covered by the test case.

14. The method of claim 6, further comprising:
selecting from the one or more maximum flows, at least one minimal-cardinality subset of test cases, wherein the selected minimal-cardinality subset is represented by a maximum-cardinality subset of critical branches with zero flow in the flow network, the critical branches being final arcs of the bipartite graph.

15. The method of claim 1, further comprising:
encoding relations between the plurality of test cases and the plurality of test requirement as domain constraints in a constraint solver.

16. The method of claim 15, wherein the evaluating is based on searching for the one or more maximum flows using the constraint solver.

17. The method of claim 15, further comprising:
removing test requirements that are covered by a single test case and including the single test case in a solution set of the constraint solver.

18. The method of claim 15, further comprising:
selecting from the one or more maximum flows at least one minimal-cardinality subset of test cases, wherein the selecting is made using the constraint solver.

19. The method of claim 15, further comprising:
controlling an execution time of the constraint solver.

20. The method of claim 1, further comprising:
initializing a residual graph with zero flow; and
when there is an augmenting path in the residual graph, increasing a flow along the augmenting path until the one or more maximum flows are found.

21. A system for reducing a size of a test suite, comprising:
at least one processor; and
memory including instructions that, when executed by the at least one processor, cause the system to:
obtain a plurality of test requirements and a plurality of test cases;
form a flow network based on the test requirements and the plurality of test cases; and
evaluate the flow network to find one or more maximum flows, wherein the one or more maximum flows represent subsets of test cases covering the plurality of test requirements.

22. The system of claim 21, wherein the instructions when executed further cause the system to:
select from the one or more maximum flows, at least one minimal-cardinality subset of test cases.

23. The system of claim 22, wherein the selecting is based on searching the one or more maximum flows using a branch-and-bound algorithm.

24. The system of claim 22, wherein the selecting is based on multiple objectives.

25. The system of claim 24, the multiple objectives comprising one or more of: fault detection capabilities, fault severity, fault relevance, test cost, test execution time, and code coverage, wherein the instructions when executed further cause the system to:
generate a bipartite graph based on the plurality of test requirements and the plurality of test cases, and wherein the flow network is formed from the bipartite graph.

26. The system of claim 25, wherein the bipartite graph is augmented with a source node S and a destination node D.

27. A computer readable storage medium storing executable instructions for reducing a size of a test suite, which when executed by a processor, causes the processor to:
obtain a plurality of test requirements and a plurality of test cases;
form a flow network based on the test requirements and the plurality of test cases; and
evaluate the flow network to find one or more maximum flows, wherein the one or more maximum flows represent subsets of test cases covering the plurality of test requirements.
